(19) United States
(12) Patent Application Publication
(10) Pub. No.: US 2024/0184369 A1
(43) Pub. Date: Jun. 6, 2024

(54) SYSTEM AND METHOD TO CONVERT AUDIO SIGNALS TO HAPTIC SIGNALS

(71) Applicant: Microchip Technology Incorporated, Chandler, AZ (US)

(72) Inventor: Razvan Costache, Dambovita (RO)

(73) Assignee: Microchip Technology Incorporated, Chandler, AZ (US)

(21) Appl. No.: 18/369,912

(22) Filed: Sep. 19, 2023

Related U.S. Application Data
(60) Provisional application No. 63/429,396, filed on Dec. 1, 2022.

(51) Int. Cl. G06F 3/01; G08B 6/00

(52) U.S. Cl. CPC G06F 3/016; G08B 6/00

(57) ABSTRACT

A device includes a receiver to receive an input audio signal and output a received audio signal, and signal conversion circuitry to apply a frequency-dependent adjustment to the received audio signal to convert the received audio signal to a haptic signal for use by a haptic actuator.

### RELATED APPLICATION

This application claims priority to commonly owned U.S. Provisional Patent Application No. 63/429,396 filed Dec. 1, 2022, the entire contents of which are hereby incorporated by reference for all purposes.

### TECHNICAL FIELD

The present disclosure relates to electronic devices, and more particularly, to devices and methods to convert audio signals to haptic signals, e.g., for driving a haptic actuator.

### BACKGROUND

Haptics include the use of electronically or mechanically generated movement that a user experiences through the sense of touch as part of an interface of an electronic device. For example, many video game controllers, gamepads, virtual reality headsets, and various other electronic devices provide vibrational feedback or other haptic effects to the user, in response to respective haptic signals programmed in a video game or other application. Such haptic effects may improve the user experience for a video game or other interactive application.

Certain electronic device designers or manufacturers, for example game controller companies, have a desire to provide haptic effects through their products, but without preprograming haptic effects for specific events occurring in the respective game or other application. For example, preprogramming haptic effects for all desired events in a respective game or application may require extensive time and programming efforts, which may inherently limit the number and type of haptic effects. In addition, haptic effects may need to be programmed for numerous games and/or other applications, which may be time intensive and expensive.

Thus, there is a need to provide haptic effects in various applications without preprograming haptic effects for specific events.

### SUMMARY

Systems and methods are disclosed for automatically and dynamically (e.g., in real time) converting an audio signal, e.g., a streaming audio signal, to a haptic signal for driving a haptic actuator, e.g., to provide haptic feedback to a person in addition to, or in place of, an audible output of a respective audio signal. In some examples the disclosed systems and methods may be implemented in a game controller (e.g., a gamepad or joystick), a headset (e.g., virtual reality headset), an earbud, or other electronic device that can be worn, held, or carried by a person. For example, the present systems and methods may be used to provide real-time haptic feedback to a person playing a game based on audio signals programmed in or otherwise associated with the game.

By automatically and dynamically converting audio signals to haptic signals, e.g., in real-time, the disclosed systems and methods may avoid the need to preprogram event-driven commands to generate haptic signals for respective events.

Some examples include equalization circuitry to apply a frequency-based gain adjustment to an audio signal to generate an equalized signal. The frequency-based gain adjustment may include filtering (e.g., blocking or attenuation) of selected frequencies (e.g., including frequencies that may produce audible output by a respective haptic actuator), while passing and/or amplifying gain of other selected frequencies (e.g., frequencies suitable for driving a respective haptic actuator), thereby providing the user with a haptic (e.g., tactile) effect without unwanted audible effects. Some examples include additional amplification circuitry to further amplify the equalized signal, e.g., to produce a haptic signal with sufficient amplitude to effectively drive a respective haptic actuator. Some examples include a pre-amplifier to provide a low voltage amplification of the equalized signal, and a high voltage amplifier to further amplify the pre-amplified equalized signal.

In some examples, the device includes a controller (e.g., a microcontroller) to dynamically adjust (e.g., enable, disable, increase and/or decrease) a voltage applied by a power source to the haptic actuator as a function of the equalized signal, for example to conserve battery usage.

One aspect provides a device including a receiver to receive an input audio signal and output a received audio signal, and signal conversion circuitry to apply a frequency-dependent adjustment to the received audio signal to convert the received audio signal to a haptic signal for use by a haptic actuator.

In some examples, the signal conversion circuitry includes equalizer circuitry to apply a frequency-based gain adjustment to the received audio signal to generate an equalized signal, and amplifier circuitry to amplify the equalized signal.

In some examples, the device includes a controller to dynamically adjust a voltage applied to the haptic actuator as a function of the equalized signal.

In some examples, the controller is programmed to disable a power supply connected to the haptic actuator for durations of the haptic signal having an amplitude below a defined non-zero threshold value.

In some examples, the equalizer circuitry comprises a filter to attenuate at least one frequency of the received audio signal. In some examples, the filter comprises a band-pass filter.

In some examples, the amplifier circuitry includes a pre-amplifier to pre-amplify the equalized signal, and a high voltage amplifier to further amplify the equalized signal.

In some examples, the receiver comprises a Bluetooth receiver.

In some examples, the device comprises a game controller. In other examples, the device comprises a virtual reality headset.

One aspect provides a device includes a receiver to receive an input audio signal and output a received audio signal, equalizer circuitry to apply a frequency-based gain adjustment to the received audio signal to generate an equalized signal, amplifier circuitry to amplify the equalized signal to generate a haptic signal to drive a haptic actuator, and a controller to dynamically adjust a voltage applied to the haptic actuator as a function of the equalized signal.

In some examples, the equalizer circuitry comprises a filter to attenuate at least one frequency range of the received audio signal.

In some examples, the filter comprises a band-pass filter.

In some examples, the amplifier circuitry includes a pre-amplifier to pre-amplify the equalized signal, and a high voltage amplifier to further amplify the equalized signal.

In some examples, the receiver comprises a Bluetooth receiver.

One aspect provides a method includes receiving an input audio signal at a receiver and outputting a received audio signal from the receiver, automatically converting the received audio signal to a haptic signal, and driving a haptic actuator based on the haptic signal.

In some examples, automatically converting the received audio signal to a haptic signal includes applying, by an equalizer circuitry, a frequency-based gain adjustment to the received audio signal to generate an equalized signal, and amplifying, by an amplifier circuitry, the equalized signal.

In some examples, the method includes dynamically adjusting, by a controller, a voltage applied to the haptic driver as a function of a reference signal. In some examples, the method includes disabling, by the controller, a power supply connected to the haptic actuator for durations of the reference signal having an amplitude below a defined non-zero threshold value. In some examples, the reference signal comprises the received audio signal or a signal derived from the received audio signal.

In some examples, applying, by the equalizer circuitry, a frequency-based gain adjustment to the received audio signal comprises applying a filter to attenuate at least one frequency range of the received audio signal.

### BRIEF DESCRIPTION OF THE DRAWINGS

Example aspects of the present disclosure are described below in conjunction with the figures, in which:

FIG. 1 shows an example system for converting an audio signal to a haptic signal for driving a haptic actuator;

FIG. 2 shows another example system for converting an audio signal to a haptic signal for driving a haptic actuator;

FIG. 3 shows an example frequency-based gain adjustment function that may be applied to an audio signal in a system for converting an audio signal to a haptic signal;

FIG. 4 is a graph illustrating example signals generated by an example device for converting an audio signal to a haptic signal for driving a haptic actuator;

FIG. 5 shows another example system for converting an audio signal to a haptic signal for driving a haptic actuator;

FIG. 6 is a flowchart of an example method 600 for controlling a haptic actuator based on a received audio signal, e.g., as implemented by any of the example systems shown in FIG. 1, FIG. 2, or FIG. 5; and

FIG. 7 is a flowchart of another example method for controlling a haptic actuator based on a received audio signal, e.g., as implemented by any of the example systems shown in FIG. 1, FIG. 2, or FIG. 5.

It should be understood the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

Example aspects of the present disclosure are described below in conjunction with the figures, in which:

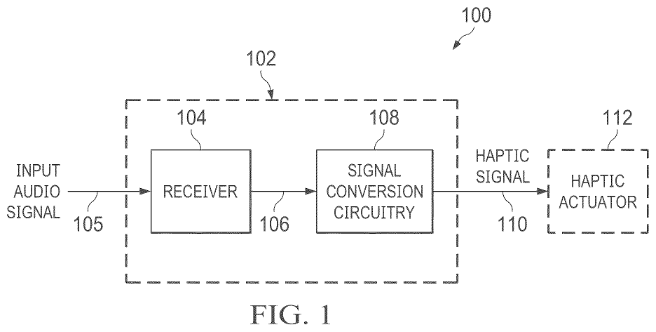

FIG. 1 shows an example system 100 including an example device 102 for converting an audio signal to a haptic signal for driving a haptic actuator. In some examples, the example system 100 may comprise a game controller (e.g., a gamepad or joystick), a headset (e.g., virtual reality headset), an earbud, or other electronic device that may include a haptic actuator 112. The example device 102 includes a receiver 104 to receive an input audio signal 105 and output a received audio signal 106, signal conversion circuitry 108 to convert the received audio signal 106 to a haptic signal 110. The haptic signal 110 may be applied to a haptic actuator 112 to generate haptic feedback (e.g., vibrations) to a user.

The input audio signal 105 may comprise any analog or digital audio signal having any audio signal waveform generated by any type of audio source. In some examples, the input audio signal 105 comprises a streaming audio signal. The input audio signal 105 may be encoded or embodied in any suitable audio codec or signal, for example MP3, Advanced Audio Coding (AAC, or MPEG-4 AAC), Waveform Audio File (WAV), Liquid Audio, RealMedia or RealMedia G2 (by Real Networks), Flash (by Macromedia), Director Shockwave (by Macromedia), Windows Media Audio (WMA) (by Microsoft), Audio Interchange File Format (by Apple), QuickTime (by Apple), Apple Lossless Audio Codec (ALAC), Rich Music Formal (RMF) (by Beatnik), Ogg Vorbis Audio Format, Free Lossless Audio Codec (FLAC), Linear Pulse Code Modulation (LCPM), Adaptive Transform Acoustic Coding (ATRAC) or any other audio signal format. In some examples, the input audio signal 105 comprises a Bluetooth audio signal, i.e., a digital audio signal encoded in any Bluetooth compatible codec (e.g., AAC, WAV, LCPM, FLAC, ALAC, MP3, WMA, or ATRAC, without limitation)

The receiver 104 may comprise any circuitry or electronics to receive the input audio signal 105, directly or indirectly, via any wired or wireless communication link, from the respective audio source, and to output the received audio signal 106. In some examples, the receiver 104 comprises circuitry to modify or otherwise process the input audio signal 105, such that the received audio signal 106 output by the receiver 104 is a modified or processed version of the input audio signal 105. For example, the receiver 104 may comprise a Bluetooth receiver (also referred to as a Bluetooth audio sink), wherein the input audio signal 105 is embodied in Bluetooth packets containing a digital audio signal (packet payload) and Bluetooth-related information (e.g., access code and packet header), and wherein the Bluetooth receiver comprises circuitry to remove respective Bluetooth-related information (e.g., access code and packet header) and output the digital audio signal as the received audio signal 106. As another example, the receiver 104 may comprise a line-in input that functions as a passthrough to receive an analog input audio signal 105 and output the analog input audio signal 105 (unmodified) as the received audio signal 106.

In some examples, the signal conversion circuitry 108 comprises circuitry to equalize the received audio signal 106 output by the receiver 104. As used herein, “equalizing” a respective signal means to apply a frequency-dependent gain adjustment over a frequency spectrum of the respective signal. The frequency-dependent gain adjustment may include decreasing (attenuating) or increasing an amplitude of the respective signal at selected frequencies. In some examples, the frequency-dependent gain adjustment may include filtering one or more selected frequencies, wherein “filtering” a respective frequency means to fully or partially attenuate an amplitude of the respective signal at the respective frequency, either in absolute terms or relative to other (non-filtered) frequencies.

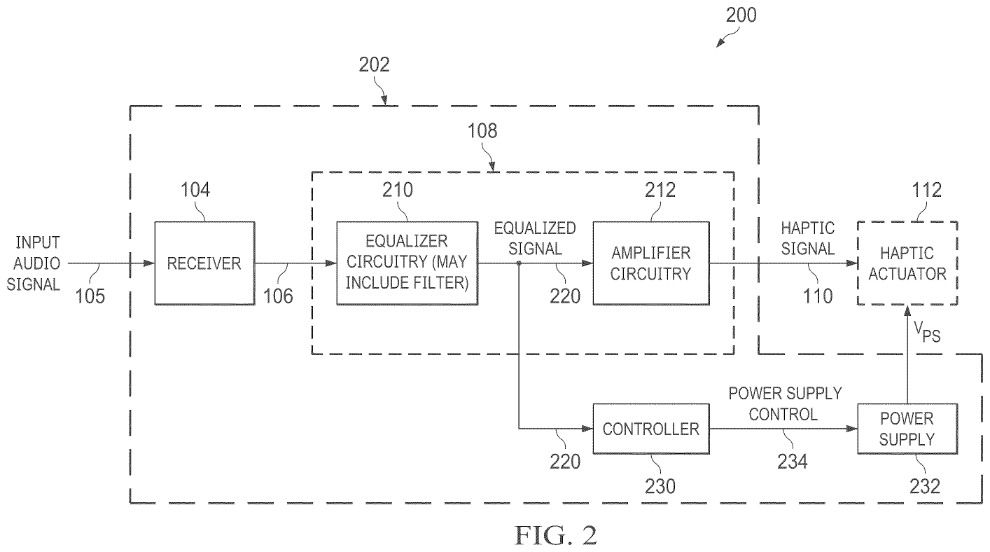

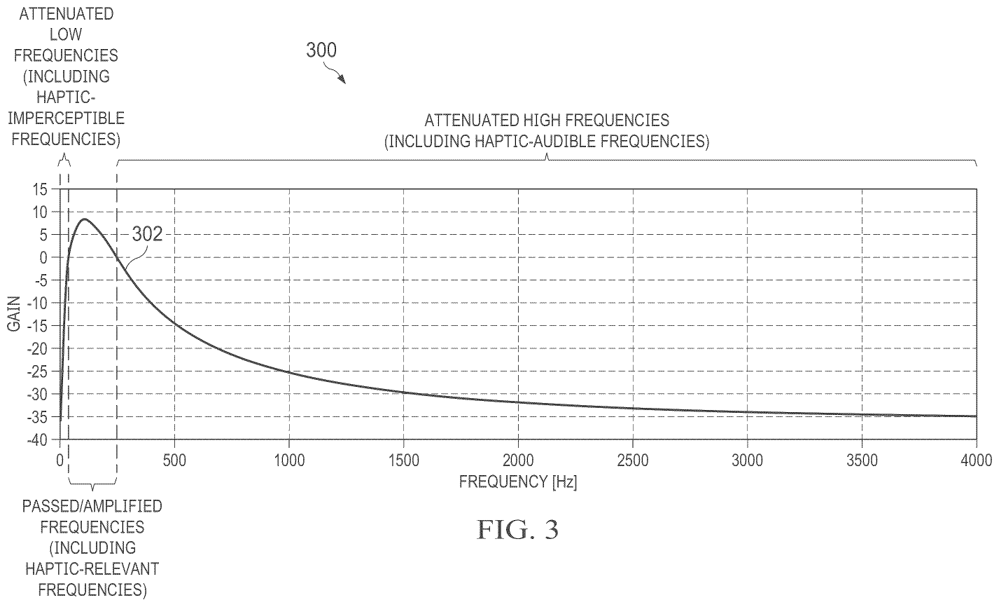

As discussed below with reference to FIGS. 2 and 3, the equalization performed by the signal conversion circuitry 108 may involve (a) filtering out (i) haptic-audible frequencies, (ii) haptic-imperceptible frequencies, and/or (iii) other selected frequencies of the received audio signal 106 while (b) passing and/or amplifying specified haptic relevant frequencies of the received audio signal 106. As used herein, “haptic relevant frequencies” refers to one or more defined frequency bands known or determined to be effective for actuating a respective haptic actuator 112 (e.g., as determined by relevant testing or in any other suitable manner) while not producing appreciable audible output from a respective haptic actuator 112. As used herein, “haptic-audible frequencies” refers to one or more defined frequency bands known or determined to produce audible output from the respective haptic actuator 112 (e.g., as determined by relevant testing or in any other suitable manner), which audible output may be undesirable. As used herein, “haptic-imperceptible frequencies” refers to one or more defined frequency bands known or determined to produce haptic output by the haptic actuator 112 that is not effectively perceptible by a typical person using the haptic actuator 112.

In some examples, the signal conversion circuitry 108 includes an equalizer to perform the relevant equalization of the received audio signal 106. In other examples, e.g., as shown in FIGS. 2 and 3 discussed below, the signal conversion circuitry 108 includes an equalizer circuit to perform an initial equalization of the received audio signal 106 to generate an “equalized signal” and at least one amplifier circuit to perform further amplification of the equalized signal, e.g., to generate the haptic signal 110.

The haptic actuator 112 may include any device that provides haptic feedback to a user in response to haptic signal 110, e.g., in contrast to visual or audible feedback. Haptic feedback may include any effects that may be sensed by a user's sense or touch, for example including tactile feedback (e.g., feedback involving the application of physical force, vibration, and/or motion), electro-tactile feedback, ultrasound feedback, or thermal feedback, without limitation. In some examples, the haptic actuator 112 may include multiple actuators, e.g., including actuators of the same or multiple different types. In some examples, the haptic actuator 112 may comprise one or more eccentric rotating mass actuator (ERM), linear resonant actuator (LRA), and/or piezoelectric actuator. In one example, the haptic actuator 112 comprises one or more Film Flex Assembled Actuator (FFAA) available from KEMET Electronics Corporation, Fort Lauderdale, FL. The haptic actuator 112 may include haptic driver circuitry for driving a respective actuator or actuators.

FIG. 2 shows an example system 200 including an example device 202 for converting an input audio signal 105 to a haptic signal 110 for driving a haptic actuator 112. Like the example device 102 discussed above, the example device 202 includes receiver 104 to receive the input audio signal 105 (e.g., a streaming audio signal) and output the received audio signal 106, and signal conversion circuitry 108 to convert the received audio signal 106 to haptic signal 110 to be applied to the haptic actuator 112 to generate haptic feedback (e.g., vibrations) to a user. The example device 202 also includes a controller 230 and a power supply 232, discussed below.

The signal conversion circuitry 108 may include equalizer circuitry 210 to apply a frequency-based gain adjustment to the received audio signal 106 to generate an equalized signal 220, and amplifier circuitry 212 to amplify the equalized signal 220 to produce the haptic signal 110. In some examples, the equalizer circuitry 210 may include a digital signal processor (DSP) including firmware (or other suitable circuitry) programmed to (a) attenuate or otherwise filter out specified haptic-audible frequencies, haptic-imperceptible frequencies, and/or other selected frequencies of the received audio signal 106 and (b) pass and/or amplify specified haptic relevant frequencies of the received audio signal 106. In some examples, the equalizer circuitry 210 includes filtering circuitry to filter the received audio signal 106 using a Sallen Key Butterworth filter topology.

FIG. 3 shows an example graph 300 showing a frequency-based gain adjustment function 302 applied to the received audio signal 106 by equalizer circuitry 210. The example frequency-based gain adjustment function 302 (a) amplifies a low-frequency band of haptic relevant frequencies, in the range of about 50-250 Hz, by applying a positive frequency-dependent positive gain, and (b) attenuates (filters) frequencies below and above the amplified frequency band (i.e., below about 50 Hz and above about 250 Hz), by applying a frequency-dependent negative gain. Accordingly, the example frequency-based gain adjustment function 302 may be referred to as a band-pass filter. The attenuated frequency band above the amplified frequency band (in this example, above about 250 Hz) includes haptic-audible frequencies. Attenuating (filtering) such haptic-audible frequencies may prevent or reduce unwanted audible outputs from the haptic actuator 112 that may cause audible perturbations or glitches. The attenuated frequency band below the amplified frequency band (in this example, below about 50 Hz) may include haptic-imperceptible frequencies. Thus, attenuating (filtering) such haptic-imperceptible frequencies may conserve power, e.g., to reduce battery usage.

It should be understood that the frequency-based gain adjustment function 302 is one example only. The equalizer circuitry 210 may apply any other suitable frequency-based gain adjustment function to the received audio signal 106 for generating a desired haptic signal 110.

The amplifier circuitry 212 may include circuitry to amplify the equalized signal 220 output by the equalizer circuitry 210 (e.g., using frequency-based gain adjustment function 302 as discussed above) to provide a sufficient voltage (of the haptic signal 110) to effectively drive the haptic actuator 112. For example, equalizer circuitry 210 (e.g., embodied in a DSP provided in a Bluetooth™ audio module) may output a low-voltage equalized signal 220, e.g., having a peak-to-peak voltage (referred to herein as the equalized signal voltage V_{ES}) of less than 2V. The amplifier circuitry 212 may amplify this low-voltage equalized signal 220 to a higher voltage signal, e.g., to provide a haptic signal 110 having a peak-to-peak voltage (referred to herein as the haptic signal voltage V_{HS}) in the range of 0V to 250V, for example a V_{HS} in range of 0V to 225V.

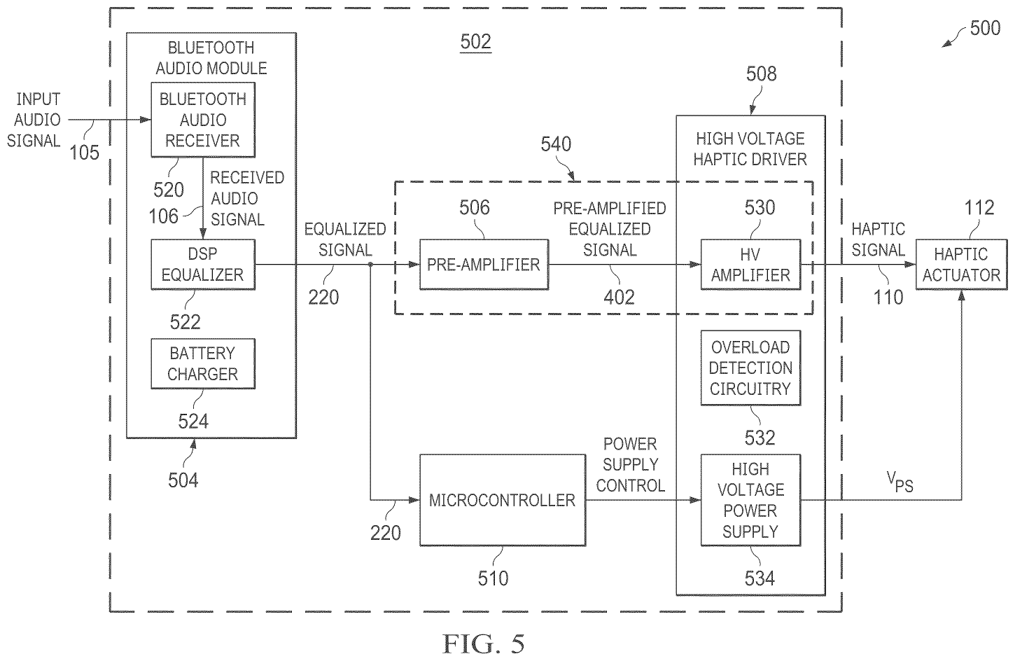

In some examples, amplifier circuitry 212 includes multiple amplifiers connected in series. For example, as discussed below with reference to FIG. 5, amplifier circuitry 212 may include (a) a pre-amplifier (e.g., a low-voltage amplifier) to pre-amplify the equalized signal 220 and (b) a high voltage amplifier to further amplify the pre-amplified equalized signal. In other examples, the equalizer circuitry 210 and amplifier circuitry 212 may be combined in an equalizer or other electronic device.

As mentioned above, the example device 202 includes controller 230 and power supply 232. The power supply 232 may comprise a battery or AC/DC converter, for example. The controller 230 may comprise circuitry to control the power supply 232 (using power supply control signals 234) to apply a voltage V_{PS} to the haptic actuator 112. In some examples, the controller 230 comprises circuitry to selectively enable/disable or otherwise dynamically adjust the voltage V_{PS} applied by power supply 232 to haptic actuator 112 as a function of the received audio signal 106 or a signal derived from the received audio signal 106 (e.g., the equalized signal 220). For example, the controller 230 may be programmed to (a) maintain the power supply 232 in an inactive or disabled state (e.g., V_{PS}=0) during durations in which an amplitude (voltage) of the reference signal (e.g., signal 106, 220, or 110) is below a respective amplitude threshold (e.g., a non-zero threshold value), and (b) activate or enable the power supply 232 to supply a voltage V_{PS} greater than or equal to the haptic signal voltage V_{HS} when the amplitude (voltage) of the equalized signal 220, haptic signal 110, or received audio signal 106 is at or above the respective amplitude threshold. In other words, the controller 230 may disable the power supply 232 between temporary “bursts” of the received audio signal 106, i.e., between durations of the received audio signal 106 with sufficient amplitude (e.g., in non-filtered frequencies) to trigger a corresponding haptic effect via the haptic actuator 112, to thereby reduce usage of the power supply 232, e.g., a battery. As used herein, “disabling” the power supply 232 may involve applying no voltage or a low voltage (insufficient to actuate to haptic actuator 112) to haptic actuator 112.

References herein to comparing an amplitude (e.g., voltage) of a respective signal to a respective threshold mean to compare the magnitude (i.e., the absolute value of the amplitude) of the respective signal to the respective threshold.

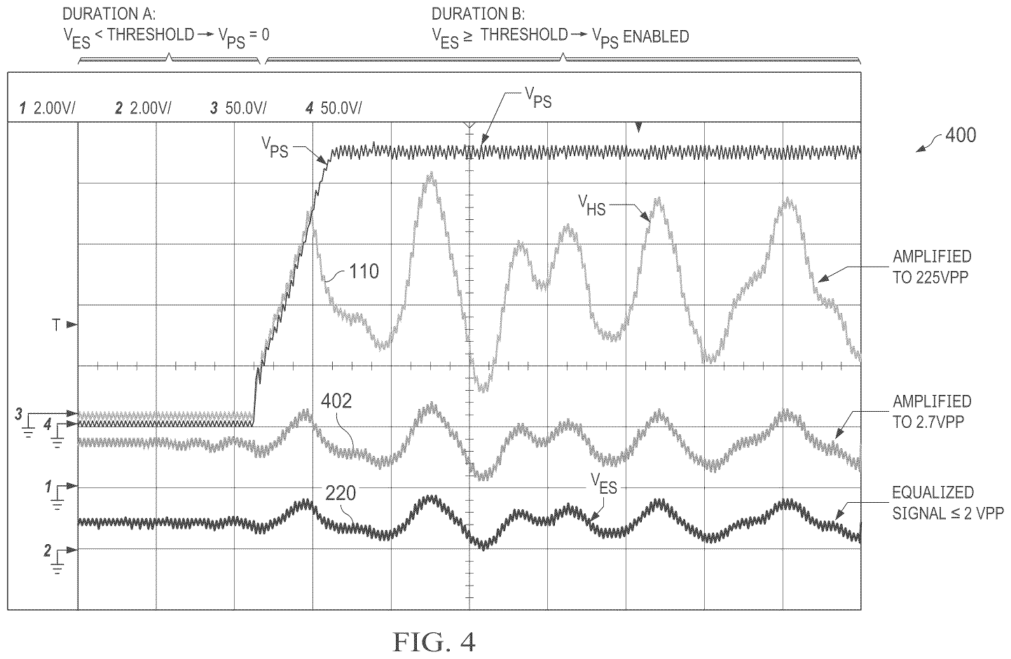

FIG. 4 is a graph 400 illustrating example signals generated by the example device 202 according to one example implementation. In particular, graph 400 shows (a) an example equalized signal 220 (having amplitude V_{ES}) output by the equalizer circuitry 210 based on an example received audio signal 106, (b) an example haptic signal 110 (having amplitude V_{HS}) output by amplifier circuitry 212, and (c) an example voltage V_{PS}, dynamically regulated by controller 230, supplied by the power supply 232 to the haptic actuator 112.

As shown, during a first time duration (Duration A) in which the amplitude V_{ES} of the equalized signal 220 is below a defined threshold value, the controller 230 remains disabled, supplying V_{PS}=0 to the haptic actuator 112, to conserve the respective power source 232. During a second time duration (Duration B) in which the amplitude V_{ES} of the equalized signal 220 meets or exceeds the defined threshold value, the controller 230 is enabled, and supplies V_{PS}≥V_{HS} (e.g., V_{PS}=225V) to the haptic actuator 112.

As discussed above, in some examples the amplifier circuitry 212 may first pre-amplify the equalized signal 220, followed by a high voltage amplification of the pre-amplified signal equalized signal to generate the resulting haptic signal 110. Accordingly, FIG. 4 also shows an example of such pre-amplified equalized signal 402, which may be further amplified (e.g., by a high voltage amplifier) to produce the haptic signal 110. In the illustrated example, the pre-amplified equalized signal 402 has a peak-to-peak voltage of about 3 Vpp, and the haptic signal 110 has a peak-to-peak voltage of 225 Vpp. It should be understood these values are examples only.

FIG. 5 shows an example system 500 including an example device 502 for converting an input audio signal 105 to a haptic signal 110 for driving a haptic actuator 112. The example device 502 may represent one example implementation of device 102 shown in FIG. 1 or device 202 shown in FIG. 2.

The example device 502 includes a Bluetooth audio module 504, a pre-amplifier 506, a high voltage haptic driver 508, and a microcontroller 510. The Bluetooth audio module 504 may include a Bluetooth audio receiver 520 for receiving the input audio signal 105 (e.g., a streaming audio signal) and outputting the received audio signal 106, a DSP equalizer 522 for equalizing the received audio signal 106, and a battery charger 524. In one example, the Bluetooth audio module 504 may comprise a BM83 device available from Microchip Technology, Inc., of Chandler, Arizona.

The Bluetooth audio receiver 520 may comprise an example implementation of the receiver 104 of the example devices 102 and 202 shown in FIGS. 1 and 2, respectively.

The DSP equalizer 522 may comprise an example implementation of the equalizer circuitry 210 of the example device 202 shown in FIG. 2 and discussed above. Accordingly, the DSP equalizer 522 may be programmed to apply a frequency-based gain adjustment (for example using the example frequency-based gain adjustment function 302 shown in FIG. 3) to the received audio signal 106 to generate an equalized signal 220. An example equalized signal 220 is shown in FIG. 4, as discussed above.

The pre-amplifier 506 includes circuitry to pre-amplify (i.e., perform a low voltage amplification of) the equalized signal 220 output by the DSP equalizer 522, to generate a pre-amplified equalized signal 402. In one example, the pre-amplifier 506 may comprise a low-voltage operational amplifier (op amp).

The high voltage haptic driver 508 may include circuitry to generate the haptic signal 110 for driving the haptic actuator 112. As shown, the high voltage haptic driver 508 may include a high voltage amplifier 530, overload detection circuitry 532, and a high voltage power supply 534. In one example, the high voltage haptic driver 508 comprises a HV56020 amplifier/haptic driver board by Microchip Technology Inc. of Chandler, AZ.

The high voltage amplifier 530 may include circuitry to further amplify the pre-amplified equalized signal 402 to generate the haptic signal 110. The pre-amplifier 506 and high voltage amplifier 530, collectively indicated at 540, may collectively represent one example implementation of the amplifier circuitry 212 of the example device 202 shown in FIG. 2 and discussed above.

In some examples, pre-amplification using the pre-amplifier 506 (or other pre-amplifier) is provided due to amplification limits of the high voltage haptic driver 508. For example, the high voltage haptic driver 508 may have a fixed gain (e.g., a fixed internal closed loop gain of 75) insufficient to amplify the equalized signal 220 (which may be a low voltage signal) to a desired or specified voltage. The pre-amplification may thus be provided for additional gain to achieve the desired or specified voltage. An example pre-amplified equalized signal 402 is shown in FIG. 4, as discussed above.

In one example, the high voltage amplifier 530 comprises a fixed-gain high voltage amplifier to amplify the pre-amplified equalized signal 402 (e.g., having a peak-to-peak voltage of 3.3 Vpp) to the haptic signal 110 having a peak-to-peak voltage of 225 Vpp. An example haptic signal 110, e.g., output by the high voltage amplifier 530, is shown in FIG. 4, as discussed above.

Overload detection circuitry 532 may include circuitry to detect and respond to an overload condition, e.g., by monitoring a voltage of the haptic actuator 112 (load), detecting such voltage falling below a defined threshold value, and generating an overload condition notification. Such overload condition notification may be used by respective circuitry of the high voltage haptic driver 508 and/or microcontroller 510 to at least temporarily block or reduce the haptic signal 110 or voltage V_{PS} applied to the haptic actuator 112.

The high voltage power supply 534 may comprise an example implementation of the power supply 232 of the example device 202 shown in FIG. 2 and discussed above. In some examples, the high voltage power supply 534 may comprise a boost or flyback regulator.

The microcontroller 510 may comprise an example implementation of the controller 230 of the example device 202 shown in FIG. 2 and discussed above. The microcontroller 510 may comprise circuitry to control the high voltage power supply 534 to dynamically adjust a voltage V_{PS} applied to the haptic actuator 112 as a function of a defined reference signal, e.g., comprising a signal derived from the received audio signal 106 (e.g., the equalized signal 220 or the pre-amplified equalized signal 402). For example, the microcontroller 510 may include circuitry to (a) maintain the high voltage power supply 534 in an inactive or disabled state (e.g., V_{PS}=0) during durations in which an amplitude (voltage) of the reference signal (e.g., signal 106, 220, 402, or 110) is below a defined amplitude threshold (e.g., a defined non-zero threshold value), and (b) activate or enable the high voltage power supply 534 to supply a voltage V_{PS} greater than or equal to the haptic signal voltage V_{HS} during durations in which the amplitude (voltage) of the reference signal (e.g., signal 106, 220, 402, or 110) is at or above the respective amplitude threshold. In other words, the microcontroller 510 may disable the high voltage power supply 534 during durations in which the received audio signal 106 does not include haptic effect-triggering characteristics, e.g., to thereby conserve battery usage. An example profile of the voltage V_{PS} controlled by the microcontroller 510 is shown in FIG. 4.

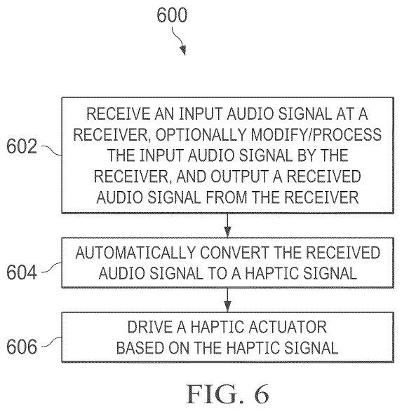

FIG. 6 is a flowchart of an example method 600 for controlling a haptic actuator based on an audio signal. In some examples, the method 600 may be implemented by any of the example devices 102, 202, or 502 to control a respective haptic actuator 112 as discussed above.

At 602, an input audio signal (e.g., a streaming audio signal) is received at a receiver, e.g., a Bluetooth audio receiver, optionally modified or otherwise processed by the receiver (e.g., to remove Bluetooth-related information from the audio signal), and output as a received audio signal. At 604, signal conversion circuitry automatically converts the received audio signal to a haptic signal. In some examples, the conversion of the received audio signal to the haptic signal may include an equalization of the received audio signal include filtering (attenuating) at least one frequency of the received audio signal, for example to filter haptic-audible frequencies, haptic-imperceptible frequencies, and/or other selected frequencies while passing and/or amplifying haptic relevant frequencies of the received audio signal. In some examples, the conversion of the received audio signal to the haptic signal may include an equalization of the received audio signal, a pre-amplification of the equalized signal, and a high voltage amplification of the pre-amplified equalized signal.

At 606, a haptic actuator may be driven based on the haptic signal. In some examples, a controller may control a power source to dynamically adjust a voltage applied to the haptic driver as a function of a reference signal (e.g., the equalized audio signal, the pre-amplified equalized signal, or other signal derived from the received audio signal), e.g., to conserve battery usage.

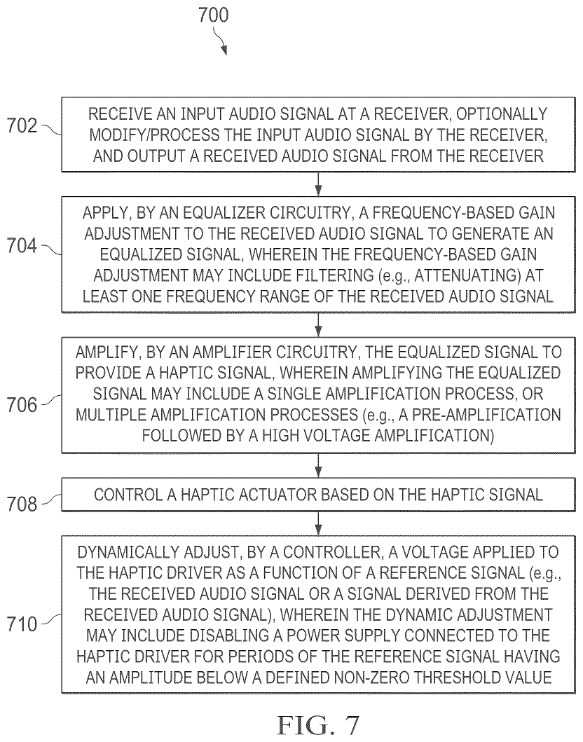

FIG. 7 is a flowchart of an example method 700 for controlling a haptic actuator based on an audio signal. In some examples, the method 700 may be implemented by any of the example devices 102, 202, or 502 to control a respective haptic actuator 112 as discussed above.

At 702, an input audio signal (e.g., a streaming audio signal) is received at a receiver, e.g., a Bluetooth audio receiver, optionally modified or otherwise processed by the receiver (e.g., to remove Bluetooth-related information from the audio signal), and output as a received audio signal. At 704, an equalizer circuitry, e.g., a DSP equalizer provided in a Bluetooth audio module, may apply a frequency-based gain adjustment to the received audio signal to generate an equalized signal. The frequency-based gain adjustment may include filtering (e.g., attenuating) at least one frequency range of the received audio signal.

At 706, an amplifier circuitry may amplify the equalized signal to provide a haptic signal. The amplification of the equalized signal may include a single amplification process, or may include multiple amplification processes (for example a pre-amplification followed by a high voltage amplification, e.g., as discussed above with reference to the pre-amplifier 506 and high voltage signal amplifier 530 shown in FIG. 5).

At 708, a haptic actuator may be controlled based on the haptic signal.

At 710, which may be performed concurrently with 708, a controller may be used to control a power source to dynamically adjust a voltage applied to the haptic driver as a function of a reference signal (e.g., the equalized signal 220, the pre-amplified equalized signal 402, or other signal derived from the received audio signal). In some examples, the dynamic adjustment may include disabling a power supply connected to the haptic actuator for durations of the reference signal having an amplitude below a defined non-zero threshold value, e.g., to conserve battery usage.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

1. A device, comprising:
a receiver to receive an input audio signal and output a received audio signal; and
signal conversion circuitry to apply a frequency-dependent adjustment to the received audio signal to convert the received audio signal to a haptic signal for use by a haptic actuator.

2. The device of claim 1, wherein the signal conversion circuitry comprises:
equalizer circuitry to apply a frequency-based gain adjustment to the received audio signal to generate an equalized signal; and
amplifier circuitry to amplify the equalized signal.

3. The device of claim 2, comprising a controller to dynamically adjust a voltage applied to the haptic actuator as a function of the equalized signal.

4. The device of claim 3, wherein the controller is programmed to disable a power supply connected to the haptic actuator for durations of the haptic signal having an amplitude below a defined non-zero threshold value.

5. The device of claim 2, wherein the equalizer circuitry comprises a filter to attenuate at least one frequency of the received audio signal.

6. The device of claim 5, wherein the filter comprises a band-pass filter.

7. The device of claim 2, wherein the amplifier circuitry comprises:
a pre-amplifier to pre-amplify the equalized signal; and
a high voltage amplifier to further amplify the equalized signal.

8. The device of claim 1, wherein the receiver comprises a Bluetooth receiver.

9. The device of claim 1, wherein the device comprises a game controller.

10. The device of claim 1, wherein the device comprises a virtual reality headset.

11. A device, comprising:
a receiver to receive an input audio signal and output a received audio signal;
equalizer circuitry to apply a frequency-based gain adjustment to the received audio signal to generate an equalized signal;
amplifier circuitry to amplify the equalized signal to generate a haptic signal to drive a haptic actuator; and
a controller to dynamically adjust a voltage applied to the haptic actuator as a function of the equalized signal.

12. The device of claim 11, wherein the equalizer circuitry comprises a filter to attenuate at least one frequency range of the received audio signal.

13. The device of claim 12, wherein the filter comprises a band-pass filter.

14. The device of claim 11, wherein the amplifier circuitry comprises:
a pre-amplifier to pre-amplify the equalized signal; and
a high voltage amplifier to further amplify the equalized signal.

15. A method, comprising:
receiving, at a receiver, an input audio signal;
outputting, from the receiver, a received audio signal;
automatically converting the received audio signal to a haptic signal; and
driving a haptic actuator based on the haptic signal.

16. The method of claim 15, wherein automatically converting the received audio signal to a haptic signal comprises:
applying, by an equalizer circuitry, a frequency-based gain adjustment to the received audio signal to generate an equalized signal; and
amplifying, by an amplifier circuitry, the equalized signal.

17. The method of claim 15, comprising dynamically adjusting, by a controller, a voltage applied to the haptic driver as a function of a reference signal.

18. The method of claim 17, comprising disabling, by the controller, a power supply connected to the haptic driver for durations of the reference signal having an amplitude below a defined non-zero threshold value.

19. The method of claim 17, wherein the reference signal comprises the received audio signal or a signal derived from the received audio signal.

20. The method of claim 15, wherein applying, by the equalizer circuitry, a frequency-based gain adjustment to the received audio signal comprises applying a filter to attenuate at least one frequency range of the received audio signal.
